(19) United States
(12) Patent Application Publication
(10) Pub. No.: US 2013/0103893 A1
(43) Pub. Date: Apr. 25, 2013

(54) SYSTEM COMPRISING STORAGE DEVICE AND RELATED METHODS OF OPERATION

(71) Applicant: Samsung Electronics Co., Ltd., Suwon-si (KR)

(72) Inventors: JAE-SOO LEE, HWASEONG-SI (KR); JOO-YOUNG HWANG, SUWON-SI (KR)

(73) Assignee: SAMSUNG ELECTRONICS CO., LTD., SUWON-SI (KR)

(21) Appl. No.: 13/655,692

(22) Filed: Oct. 19, 2012

(30) Foreign Application Priority Data
Oct. 20, 2011 (KR) 10-2011-0107578

(51) Int. Cl. G06F 12/02; G06F 12/10

(52) U.S. Cl. 711/103; 711/102; 711/203; 711/E12.061; 711/E12.008; 711/E12.007

(57) ABSTRACT

A memory system comprises a storage device and a host. The host classifies pages stored in the storage device into a plurality of data groups according to properties of the pages, and transmits setup information regarding the classified data groups to the storage device.

### CROSS-REFERENCE TO RELATED APPLICATIONS

This application claims priority under 35 U.S.C. §119 to Korean Patent Application No. 10-2011-0107578 filed on Oct. 20, 2011, the subject matter of which is hereby incorporated by reference.

### BACKGROUND OF THE INVENTION

The inventive concept relates generally to electronic data storage technologies. More particularly, the inventive concept relates to a storage device comprising a nonvolatile memory device and a method of controlling an interface of the storage device.

A nonvolatile memory device is a memory device capable of retaining stored information even when disconnected from power. An example of a nonvolatile memory device is a flash memory device. The performance and lifetime of a nonvolatile memory device such as a flash memory device may vary according to an address mapping method and a usage pattern of memory cells. For instance, an address mapping method or usage pattern that accesses some memory cells more frequently than others will tend to shorten the lifetime of those memory cells. Consequently, there is a general need for systems and methods with address mapping and usage patterns that produce favorable performance and extended lifetime.

### SUMMARY OF THE INVENTION

According to an embodiment of the inventive concept, a method comprises classifying pages stored in a solid state drive into a plurality of data groups according to properties of the pages, and transmitting setup information regarding the classified data groups to the solid state drive.

According to another embodiment of the inventive concept, a method comprises receiving from a host device data group information for a plurality of data groups and parameter values used to perform address translation on each of the groups, and translating a logical address of data to be stored into a physical address based on the received data group information and the parameter values corresponding to the respective groups.

According to another embodiment of the inventive concept, a system comprises a solid state drive comprising a nonvolatile memory device, and a host device configured to classify pages stored in the solid state drive into a plurality of data groups according to properties of the pages, and further configured to transmit setup information regarding the classified data groups to the solid state drive.

These and other embodiments of the inventive concept can potentially improve the performance of a system comprising a solid state drive as well as the lifetime of a memory device within the solid state drive.

### BRIEF DESCRIPTION OF THE DRAWINGS

The drawings illustrate selected embodiments of the inventive concept. In the drawings, like reference numbers indicate like features.

FIG. 1 is a block diagram of a data storage system according to an embodiment of the inventive concept.

FIG. 2 is a block diagram of a host device illustrated in FIG. 1 according to an embodiment of the inventive concept.

FIG. 3 is a diagram for describing a group assignment method according to an embodiment of the inventive concept.

FIG. 4 is a diagram showing specifications of a data group setup command according to an embodiment of the inventive concept.

FIG. 5 is a diagram illustrating a method of classifying data usage patterns according to an embodiment of the inventive concept.

FIG. 6 is a diagram illustrating a method of classifying data of a logical address region into a plurality of groups and an example of log blocks assigned to each group according to an embodiment of the inventive concept.

FIG. 7 is a diagram of an information storage region of a memory device illustrated in FIG. 1 according to an embodiment of the inventive concept.

FIG. 8 is a diagram of a flash memory used as the memory device illustrated in FIG. 1 according to an embodiment of the inventive concept.

FIG. 9 is a diagram illustrating an internal storage structure of the flash memory illustrated in FIG. 8 according to an embodiment of the inventive concept.

FIG. 10 is a diagram illustrating a software structure of the data storage system of FIG. 1 according to an embodiment of the inventive concept.

FIG. 11A is a diagram illustrating a page mapping method according to an embodiment of the inventive concept.

FIG. 11B is a diagram illustrating a block mapping method according to an embodiment of the inventive concept.

FIG. 11C is a diagram illustrating a hybrid mapping method according to an embodiment of the inventive concept.

FIG. 11D is a diagram illustrating a 2-block associative mapping method according to an embodiment of the inventive concept.

FIG. 12 is a flowchart illustrating an interface management method according to an embodiment of the inventive concept.

FIG. 13 is a flowchart illustrating a transmission operation illustrated in FIG. 12 according to an embodiment of the inventive concept.

FIG. 14 is a flowchart illustrating a mapping method for a storage device illustrated in FIG. 1 according to an embodiment of the inventive concept.

FIG. 15 is a flowchart illustrating an address translation operation illustrated in FIG. 14 according to an embodiment of the inventive concept.

FIG. 16 is a flowchart illustrating a write method for the storage device illustrated in FIG. 1, according to an embodiment of the inventive concept.

FIG. 17 is a block diagram of a computer system according to an embodiment of the inventive concept.

FIG. 18 is a block diagram of a memory card according to an embodiment of the inventive concept.

FIG. 19 is a block diagram of a network system comprising a data storage system according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

The terminology used herein is for the purpose of describing particular embodiments and is not intended to limit the inventive concept. As used herein, the singular forms “a”, “an”, and “the” are intended to include the plural forms as well, unless the context clearly indicates otherwise. It will be further understood that terms such as “comprises” and/or “comprising,” and “includes” and/or “including”, where used in this specification, indicate the presence of stated features, integers, steps, operations, elements, and/or components, but do not preclude the presence or addition of other features.

Unless otherwise defined, all terms used in the description, including technical and scientific terms, have the same meaning as generally understood by one of ordinary skill in the art. Terms such as those defined in a commonly used dictionary should be construed as having the meaning as understood in the relevant technical context and should not be interpreted in an overly formal or idealized manner unless expressly so defined herein. As used herein, expressions such as “at least one of,” when preceding a list of elements, modify the entire list of elements.

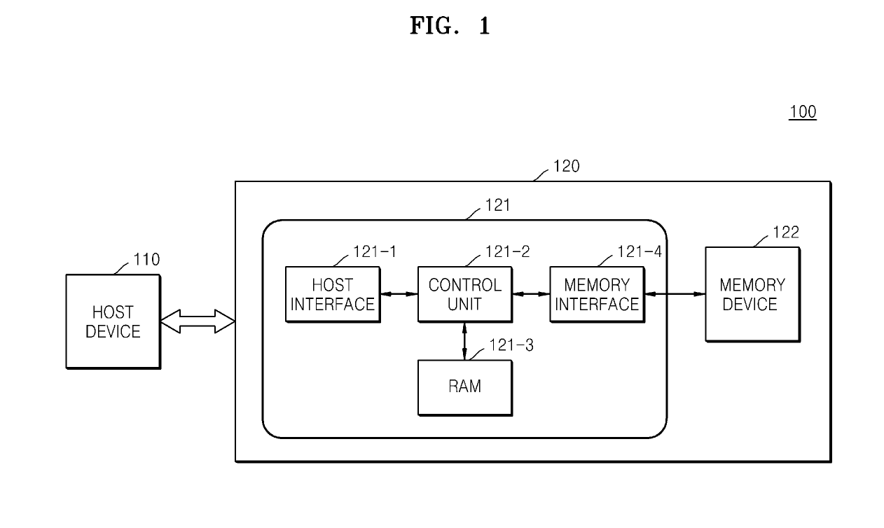

FIG. 1 is a block diagram of a data storage system 100 according to an embodiment of the inventive concept. As illustrated in FIG. 1, data storage system 100 comprises a host device 110 and a storage device 120.

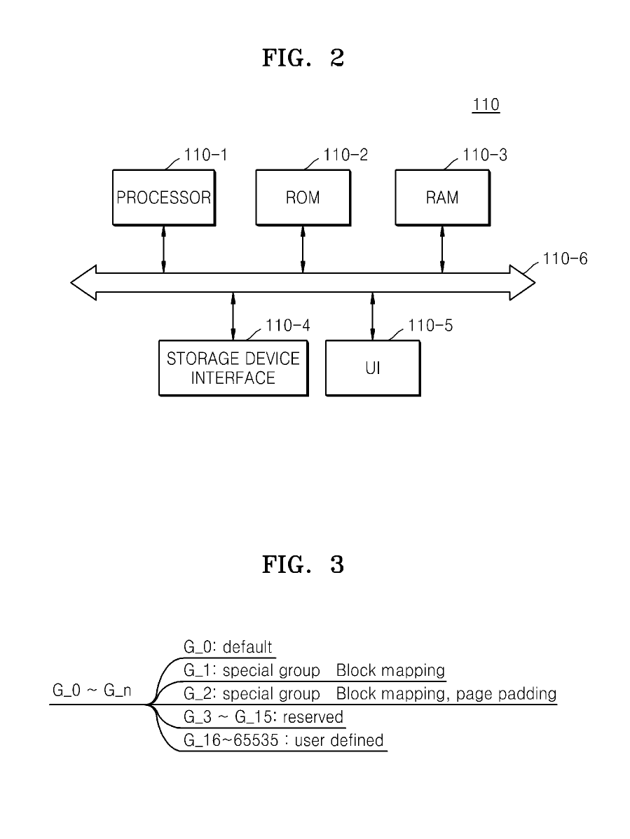

FIG. 2 is a block diagram of host device 110 according to an embodiment of the inventive concept. As illustrated in FIG. 2, host device 110 comprises a processor 110-1, a read only memory (ROM) 110-2, a random access memory (RAM) 110-3, a storage device interface 110-4, a user interface (UI) 110-5, and a bus 110-6.

Bus 110-6 comprises a transmission channel for transmitting data to other components of host device 110.

ROM 110-2 typically stores one or more application programs. For example, it may store application programs supporting storage protocols such as Advanced Technology Attachment (ATA), Small Computer System Interface (SCSI), embedded Multi Media Card (eMMC), and Unix File System (UFS) protocols are stored. In addition, it may also store software for an fdisk tool or data group command sets.

The data group command sets may be defined to be applicable to storage protocols such as the ATA, SCSI, eMMC, and UFS protocols. For example, a data group command set applicable to the ATA protocol may be defined to support 65536 (unsigned 16 bits) group numbers. From among the group numbers, some group numbers may be reserved.

FIG. 3 is a diagram for describing a group assignment method according to an embodiment of the inventive concept.

Referring to FIG. 3, a group number G_0 represents a default group and is an initial group number of all data blocks. A group number G_1 is a group number of data blocks where one data block forms one group. A group number G_2 is a group number of data blocks where one data block using page padding forms one group. Group numbers G_3 through G_15 are reserved group numbers. Group numbers G_16 through G_65535 are user-definable group numbers.

A data group command set may use a command code 06h (data set management), which is already defined according to the ATA protocol, and may use a feature code to identify a command. Currently, a command using command code 06h is TRIM (feature code 0).

Host device 110 uses an identify command to determine whether storage device 120 provides a certain command set. Whether a command set is provided may be determined by checking the structure of an identifier (ID) returned as a result of executing the identify command. For example, whether a data group command set is provided may be represented by using (((short*)data)[169]) bit 1 of a 170^{th} word.

A data group reset command is a command for completely initializing the definition of data groups, and may use 10h as a feature code. Where the data group reset command is executed, all data blocks may be assigned to data #0.

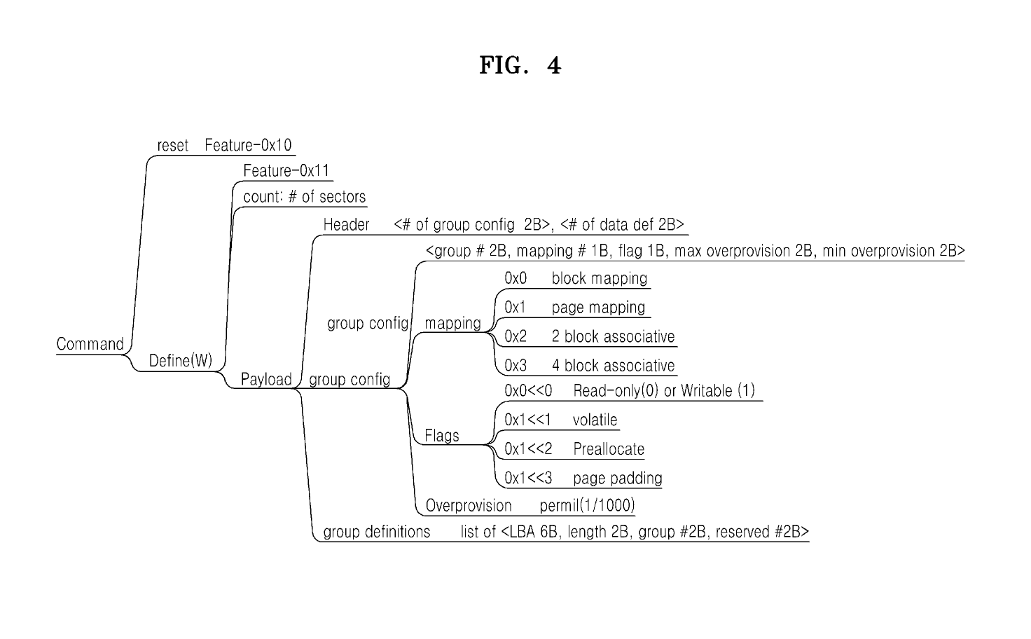

FIG. 4 is a diagram showing specifications of a data group setup command according to an embodiment of the inventive concept. The specifications define data groups, which may be set according to the range of each pages.

Referring to FIG. 4, 11h is used as a feature code and a sector count value is set as the number of sectors of data to be transmitted. Data transmitted from host device 110 to storage device 120 together with the data group setup command may comprise a header, group environment setup information (group configuration), and data block region information (group definition).

The header has 4 bytes, where the first two bytes represent the number of groups to be defined by the data group setup command, and the other two bytes represent the number of data block regions to be defined.

One data group defined by the group environment setup information has 8 bytes, with each byte defined as follows. Bytes 0 and 1 represent a group number. Byte 2 represents a mapping algorithm. For example, byte 2 may have a value 0 representing a block mapping method, a value 1 representing a fully-associative page mapping method, a value 2 representing a 2-block associative mapping method, or a value 3 representing a 4-block associative mapping method. Byte 3 represents a flag. In byte 3, 0x1 represents a writable region, 0x2 represents a volatile region, 0x4 represents performance of preallocation, and 0x8 represents performance of page padding. The page padding is ignored if byte 2 does not represent the block mapping method. Bytes 4 and 5 are used to set a value of maximum over-provision. The maximum over-provision represents a ratio of a maximum number of allocable log blocks to the number of data blocks per mil. Where bytes 4 and 5 have a value 0, it means no restriction. Bytes 6 and 7 are used to set a value of minimum over-provision. The minimum over-provision may be set as a value representing a ratio of a minimum number of allocable log blocks to the number of data blocks per mil. If bytes 6 and 7 have a value 0, it means no restriction.

The data block region information is assigned to each data block region. A data block region represents continuous data blocks, and is described by a sector number of a start data sector and the number of sectors. In this case, the sector number of a start data sector and the number of sectors should be multiples of the number of sectors in each data block. For example, the data block region information may have 12 bytes, and each byte may be defined as follows. Bytes 0 through 5 represent a sector number of a start data sector, bytes 6 and 7 represent the number of sectors, bytes 8 and 9 represent a group number of a group to be assigned, and bytes 10 and 11 are reserved bytes.

The above-described commands are merely examples and may be defined differently according to specific protocols. Also, it should be understood that the data group setup command may be divided and transmitted in multiple units, or may change existing setup values.

Referring again to FIG. 2, RAM 110-3 temporarily stores data or programs. UI 110-5 is a physical or virtual medium for exchanging information between a user and host device 110, such as a computer program, etc. It typically comprises both hardware and software. For example, UI 110-5 may comprise an input device allowing the user to manipulate host device 110, and an output device for outputting a result of processing an input of the user.

Processor 110-1 controls overall operations of host device 110. Processor 110-1 classifies data stored in storage device 120 into a plurality of data groups according to properties of pages by using an application or tool stored in ROM 110-2, and transmits information regarding the data groups via storage device interface 110-4 to storage device 120.

Initially, processor 110-1 groups pages of data stored in storage device 120 into data groups having common properties. For example, the data groups may formed by units of a data block region comprising data blocks having continuous logical addresses.

Processor 110-1 may classify usage patterns of the pages according to properties of files forming the pages. The properties of the files may be determined, for example, based on extension information of the files. Moreover, the pages may be grouped into a random data group, a sequential data group, a volatile data group, a streaming data group, etc. according to the properties of the file. For example, the random data group may include metadata, the sequential data group may include executable file data, and the volatile data group may include web page data or swap file data.

Also, processor 110-1 may classify the pages into a hot data group and a cold data group according to the usage patterns of pages. That is, the pages may be classified into a hot data group and a cold data group according to frequencies of updates on the pages. Both the hot data group and the cold data group may be further classified into a plurality of groups according to the frequency of updates.

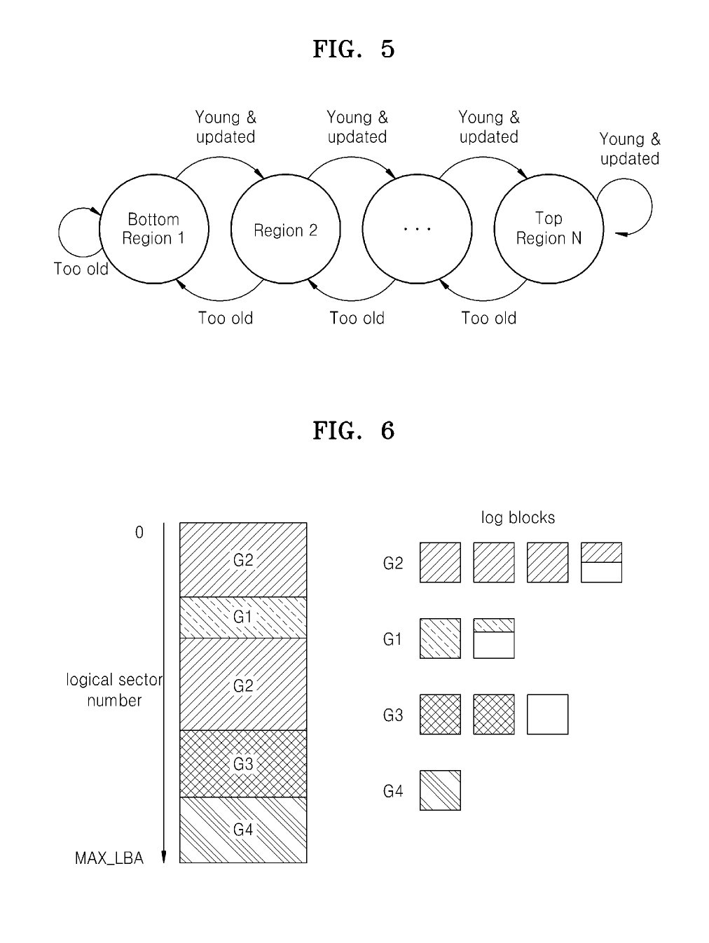

FIG. 5 is a diagram illustrating a method of classifying data usage patterns according to an embodiment of the inventive concept. The hot data group and the cold data group, for example, may be classified using the method of FIG. 5.

Referring to FIG. 5, a bottom region 1 corresponds to a cold data group having a lowest frequency of updates, and a top region N corresponds to a hot data group having a highest frequency of updates. A region 2 has a higher frequency of updates in comparison to bottom region 1, and has a lower frequency of updates in comparison to top region N.

Whenever a data group is updated, the data group moves toward top region N by one level. Also, if a data group is not updated for an initially set period of time, the data group moves toward bottom region 1 by one level. As such, the frequency of updates on each data group may be detected.

FIG. 6 is a diagram illustrating a method of classifying data of a logical address region into a plurality of groups using the method of FIG. 5 and an example of log blocks assigned to each group according to an embodiment of the inventive concept.

Referring to FIG. 6, the data of the logical address region is classified into four data groups G1 through G4. Storage device 120 assigns log blocks to each data group. Like data group G2 illustrated in FIG. 6, discontinuous pages may be classified into one data group.

A group number of each data group may be set as described above in relation to FIG. 3. For example, the group number of each data group may be set by using user-designated group numbers from among group numbers 16 through 65535 G_16 through G_65535.

Then, processor 110-1 determines the group environment setup information and the data block region information of each group. For example, the group environment setup information of each group may be determined by using a lookup table.

The lookup table may be formed to designate mapping information, flag information, and over-provision information to each data group, which are set by using the data group setup command illustrated in FIG. 4. For example, the lookup table may be formed to designate a fully-associative page mapping method to a data group having a high frequency of updates on pages, and to designate a block mapping method to a data group having a low frequency of updates on pages. Also, the lookup table may be formed to designate a 2-block associative mapping method or a 4-block associative mapping method to a data group having a medium frequency of updates on pages. The lookup table may be formed to designate the 4-block associative mapping method to a data group having a lower frequency of updates on pages in comparison to the 2-block associative mapping method.

In further detail, the lookup table may be formed to designate a fully-associative page mapping method to a random data group having a high frequency of updates. Also, the lookup table may be formed to designate a block mapping method to a sequential data group.

The lookup table may be formed to designate one of a 2-block associative mapping method and a 4-block associative mapping method to a sequential data group having a relatively high frequency of updates. Then, the lookup table may be formed to designate the flag information representing a writable region, a volatile region, preallocation, or page padding to each data group.

The lookup table may be formed to designate the flag information representing a nonvolatile region to a data group including web pages or swap pages. Also, the lookup table may be formed to designate the flag information representing preallocation to a data group including streaming pages. Then, the lookup table may be formed to designate the over-provision information to each data group. In more detail, the lookup table may set a maximum over-provision value or a minimum over-provision value to each data group.

A minimum number of log blocks in each data group influences maximum and minimum throughputs of the data group. That is, the number of log blocks allocable to a data group is large, and thus a throughput of the data group is improved. Because the number of log blocks allocable by a memory device 122 is limited, a maximum or minimum number of log blocks allocable to each group may be set in consideration of the frequency of updates. Also, the maximum or minimum number of log blocks allocable to each group may be set to be unlimited.

The lookup table formed as described above may be stored in ROM 110-2.

Processor 110-1 forms setup information regarding the data groups by using the data group command sets and the lookup table. Here, the setup information regarding the data groups may include data group information and parameter values used to perform address translation on each group. For example, the data group information may include information for designating a data group in a data block region including data blocks having continuous logical addresses.

Processor 110-1 transmits a data group setup command code and the setup information regarding the data groups formed by using the data group command sets and the lookup table via storage device interface 110-4 to storage device 120.

Processor 110-1 may change assignment of each pages while a file system operates. One file system may include a plurality of data groups.

Storage device interface 110-4 may include an interface supporting a storage protocol, e.g., an ATA interface, a SATA interface, a PATA interface, a USB or SAS interface, a SCSI interface, an eMMC interface, or a UFS interface.

Referring again to FIG. 1, storage device 120 comprises a memory controller 121 and a memory device 122. Memory controller 121 comprises a host interface 121-1, a control unit 121-2, a RAM 121-3, and a memory interface 121-4. Where memory device 122 is implemented as nonvolatile semiconductor memory such as flash memory, storage device 120 may be a solid state drive (SSD).

Memory controller 121 controls erase, write, and read operations of memory device 122 in response to commands received from host device 110.

Control unit 121-2 controls overall operations of storage device 120. For example, control unit 121-2 reads commands received from host device 110 and controls storage device 120 to perform an operation according to the commands.

Host interface 121-1 implements a protocol for exchanging data with host device 110 that accesses storage device 120, and connects storage device 120 and host device 110 to each other. Host interface 121-1 may be implemented as, for example, an ATA interface, a SATA interface, a PATA interface, a USB or SAS interface, an SCSI interface, an eMMC interface, or a UFS interface. Host interface 121-1 exchanges commands, addresses, and data with host device 110 by the control of control unit 121-2.

Also, storage device 120 receives data group setup command information via host interface 121-1 from host device 110. Storage device 120 receives the data group setup command code and the setup information regarding the data groups via host interface 121-1 from host device 110. The data group setup command information received from host device 110 is stored in RAM 121-3.

Control unit 121-2 sets parameter values used to perform address translation on each group based on the data group setup command information stored in RAM 121-3. For example, if the data group setup command code and the setup information regarding the data groups are received as illustrated in FIG. 4 from host device 110, control unit 121-2 may set parameter values used to perform address translation on each group, e.g., a mapping method and the number of allocable log blocks of each group, based on the received setup information regarding the data groups.

Memory interface 121-4 is electrically connected to memory device 122. Memory interface 121-4 exchanges commands, addresses, and data with memory device 122 under control of control unit 121-2. Memory interface 121-4 is typically configured to support NAND flash memory or NOR flash memory. Memory interface 121-4 may be formed to selectively perform software and hardware interleave operations via a plurality of channels.

Control unit 121-2 provides a read command and an address to memory device 122 in a read operation, and provides a write command, an address, and data to memory device 122 in a write operation. Also, control unit 121-2 translates a logical address received from host device 110 into a physical address by using the data group setup command information and metadata stored in RAM 121-3.

The metadata is data generated by storage device 120 in order to manage user data or memory device 122. The metadata comprises the mapping information used to translate a logical address into a physical address of memory device 122. Also, the metadata may comprise information for managing the storage space of memory device 122.

Where power is supplied to storage device 120, control unit 121-2 reads the metadata stored in memory device 122 and controls storage device 120 to store the metadata in RAM 121-3. Control unit 121-2 controls storage device 120 to update the metadata stored in RAM 121-3 according to an operation of changing the metadata in memory device 122. Also, control unit 121-2 controls storage device 120 to write the updated metadata stored in RAM 121-3 into memory device 122 before the power supplied to storage device 120 is cut off.

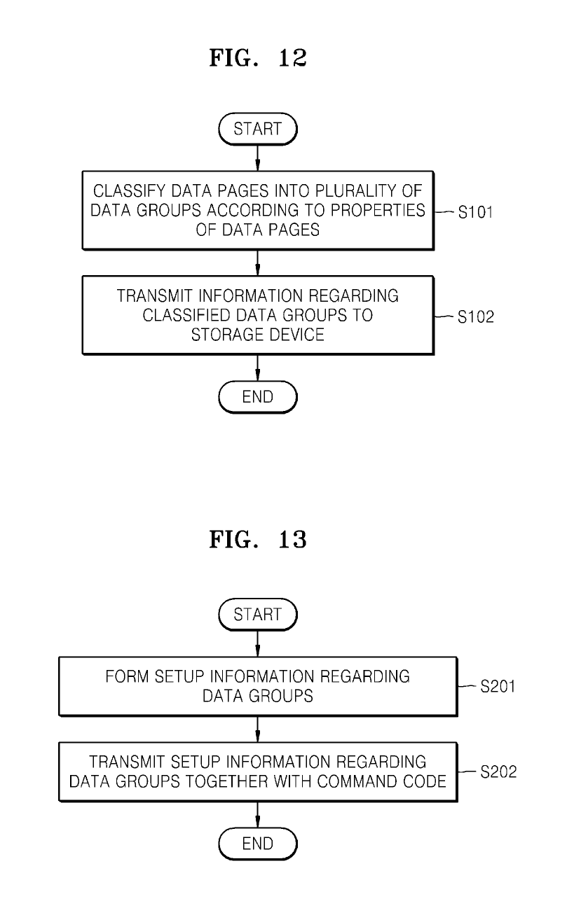

An interface management method and a mapping method performed according to the control operation of control unit 121-2 will be described in detail later below with reference to FIGS. 12 through 15.

RAM 121-3 temporarily stores data transmitted from host device 110, data generated by control unit 121-2, and data to be transmitted to host device 110. Also, RAM 121-3 has regions allocated to store the metadata, the data group information, and the parameter values regarding each group. RAM 121-3 may be implemented as, for example, DRAM or SRAM.

Memory device 122 may be implemented as a nonvolatile semiconductor memory device such as flash memory, phase-change RAM (PRAM), ferroelectric RAM (FRAM), or magnetic RAM (MRAM).

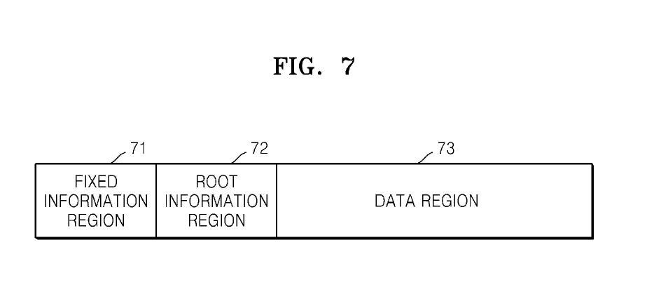

Referring to FIG. 7, the storage region of memory device 122 is divided into a fixed information region 71, a root information region 72, and a data region 73.

Fixed information region 71 stores unique information of memory device 122, e.g., information regarding a file system, a version, and the number of pages in each block. Root information region 72 stores information regarding a location where the metadata is stored. Also, data region 73 stores the metadata and user data. Data region 73 is divided into a metadata storage region and a user data region.

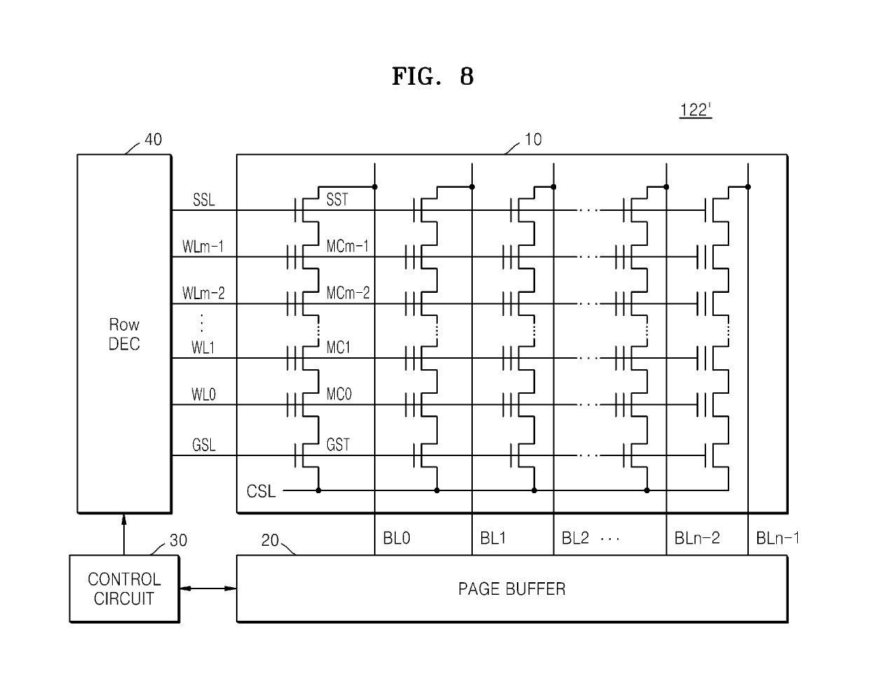

FIG. 8 is a diagram of a flash memory 122′ used as memory device 122 of FIG. 1 according to an embodiment of the inventive concept.

Referring to FIG. 8, flash memory 122′ comprises a cell array 10, a page buffer 20, a control circuit 30, and a row decoder 40.

Cell array 10 is a region where data is written by applying a certain voltage to a transistor. Cell array 10 comprises memory cells where word lines WL0 through WLm-1 and bit lines BL0 through BLn-1 overlap each other. Here, m and n are natural numbers. Although one memory block is illustrated in FIG. 8, cell array 10 may comprise a plurality of memory blocks. Each memory block comprises pages corresponding to word lines WL0 through WLm-1. Each page comprises a plurality of memory cells connected to each word line. Flash memory 122′ performs an erase operation in units of a block, and performs a program or read operation in units of a page.

Cell array 10 has a structure of cell strings. Each cell string comprises a string selection transistor SST connected to a string selection line SSL, a plurality of memory cells MC0 through MCm-1 respectively connected to word lines WL0 through WLm-1, and a ground selection transistor GST connected to a ground selection line GSL. Here, string selection transistor SST is connected between a bit line and a string channel, and ground selection transistor GST is connected between the string channel and a common source line CSL.

Page buffer 20 is connected via bit lines BL0 through BLn-1 to cell array 10. Page buffer 20 temporarily stores data to be written into or data read from memory cells connected to a selected word line.

Control circuit 30 generates various voltages required to perform write or read, and erase operations. It also receives control signals, and controls overall operations of flash memory 122′.

Row decoder 40 is connected to cell array 10 via string selection line SSL, ground selection line GSL, and word lines WL0 through WLm-1. In a write or read operation, row decoder 40 receives an address and selects any one word line according to the received address. Here, the selected word line is connected to memory cells on which the write or read operation is to be performed.

Also, row decoder 40 applies voltages to perform a program or read operation, e.g., a program voltage, a pass voltage, a read voltage, a string selection voltage, and a ground selection voltage, to the selected word line, unselected word lines, string selection line SSL, and ground selection line GSL.

Each memory cell may store one-bit data or two-or-more-bit data. A memory cell for storing one-bit data is referred to as a single level cell (SLC), and a memory cell for storing two-or-more-bit data is referred to as a multi level cell (MLC). An SLC has an erase or program state according to a threshold voltage.

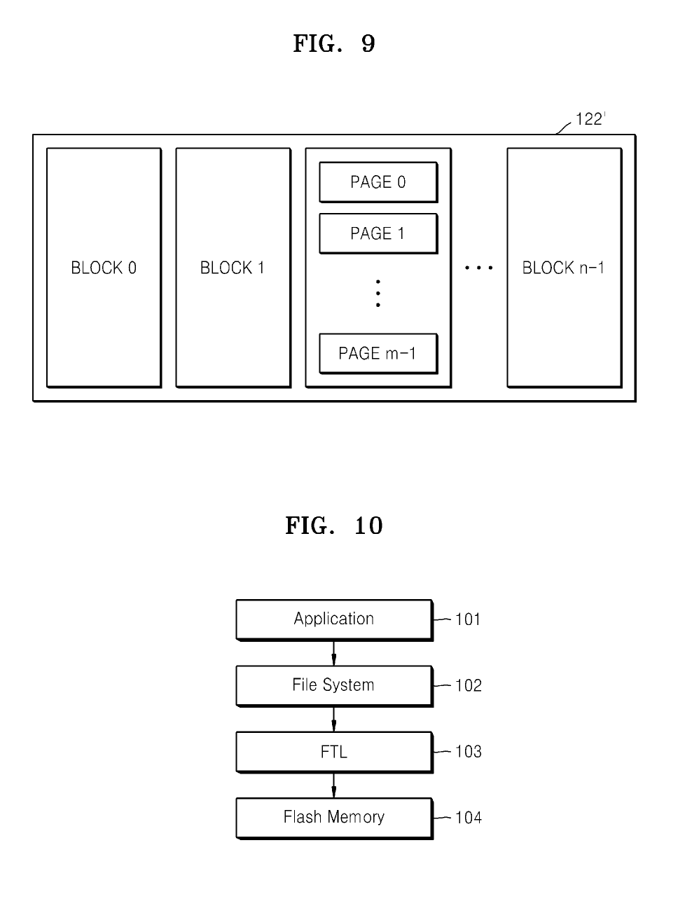

FIG. 9 is a diagram illustrating an internal storage structure of flash memory 122′ illustrated in FIG. 8 according to an embodiment of the inventive concept.

Referring to FIG. 9, flash memory 122′ comprises a plurality of blocks each including a plurality of pages. Flash memory 122′ writes and reads data in units of a page, and electrically erases data in units of a block. Also, an electrical erase operation of a block is required before a write operation is performed. As such, an overwrite operation is disabled.

A non-overwritable memory device may not write user data into a user-desired physical region. Accordingly, if access to a region for writing or reading user data is requested by a user, address translation for translating a logical address of the region into a physical address of a physical region in which the user data is or in which it is to be actually stored is required.

FIG. 10 is a diagram illustrating a software structure of data storage system 100 of FIG. 1 according to an embodiment of the inventive concept. An operation of translating a logical address into a physical address in data storage system 100 is described below with reference to FIG. 10.

Referring to FIG. 10, data storage system 100 has a software layer structure comprising an application 101, a file system 102, a flash translation layer (FTL) 103, and flash memory 104. Flash memory 104 corresponds to flash memory 122′ illustrated in FIGS. 8 and 9.

Application 101 refers to firmware for processing user data in response to an input of a user via UI 110-5. For example, application 101 may be document processing software such as a word processor, calculation software, or a document viewer such as a web browser. Application 101 processes user data in response to an input of a user, and transmits a command for storing the processed user data in flash memory 104 to file system 102. Also, application 101 may transmit a data group setup command to file system 102.

File system 102 refers to a structure or software used to store the user data in flash memory 104. File system 102 assigns a logical address for storing the user data in response to the command transmitted from application 101. File system 102 may be, for example, a file allocation table (FAT) file system or a new technology file system (NTFS).

FTL 103 translates the logical address received from file system 102 into a physical address for performing a read/write operation on flash memory 104. FTL 103 translates the logical address into the physical address by using mapping information in metadata.

FTL 103 assigns a group number to each logical data block (a set of continuous logical pages having the same size as a physical block). The number of allocable group numbers may be limited. FTL 103 may assign log blocks to each data group, as illustrated in FIG. 6. FTL 103 may set a maximum or minimum number of log blocks allocable to each group according to a value designated in over-provision information. FTL 103 may support, for example, a persistent preallocation feature for previously assigning log blocks to a group, and a page padding feature.

In more detail, FTL 103 performs address translation a write operation based on data group setup command information transmitted from host device 110. That is, a data group assigned to a data block comprising a logical address for performing a write operation may be found by using data block region information in the data group setup command information. For reference, the data block region information is defined as <group definitions> in the specifications of a data group setup command illustrated in FIG. 4.

After the data group corresponding to the logical address for performing the write operation is found, group environment setup information regarding the found data group is found. For reference, the group environment setup information is defined as <group config> in the specifications of the data group setup command illustrated in FIG. 4.

Then, the address translation is performed based on the group environment setup information regarding the data group corresponding to the logical address for performing the write operation. As described above in relation to FIG. 4, the group environment setup information may comprise mapping information, flag information, and over-provision information of the data group. FTL 103 may set a mapping method of the data group based on the mapping information. Also, FTL 103 may set whether the data group is writable, is volatile, uses preallocation, or uses page padding, based on the flag information. Furthermore, FTL 103 may set a minimum or maximum number of log blocks in the data group based on the over-provision information.

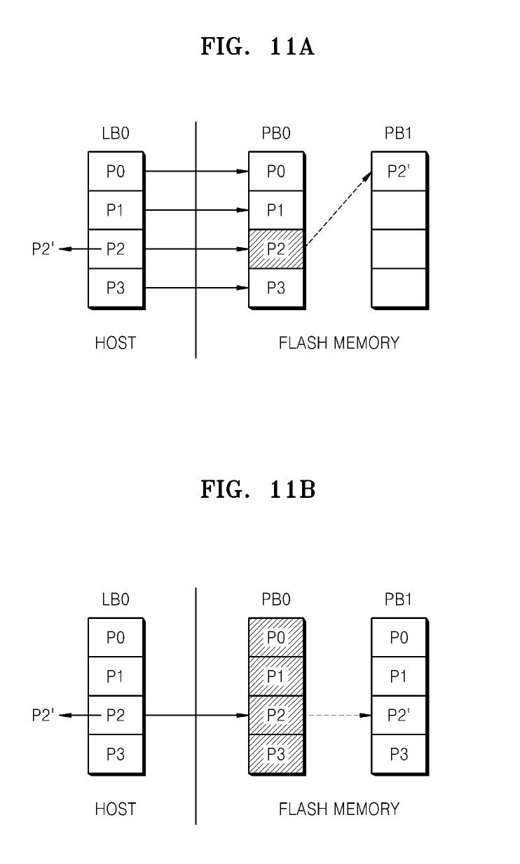

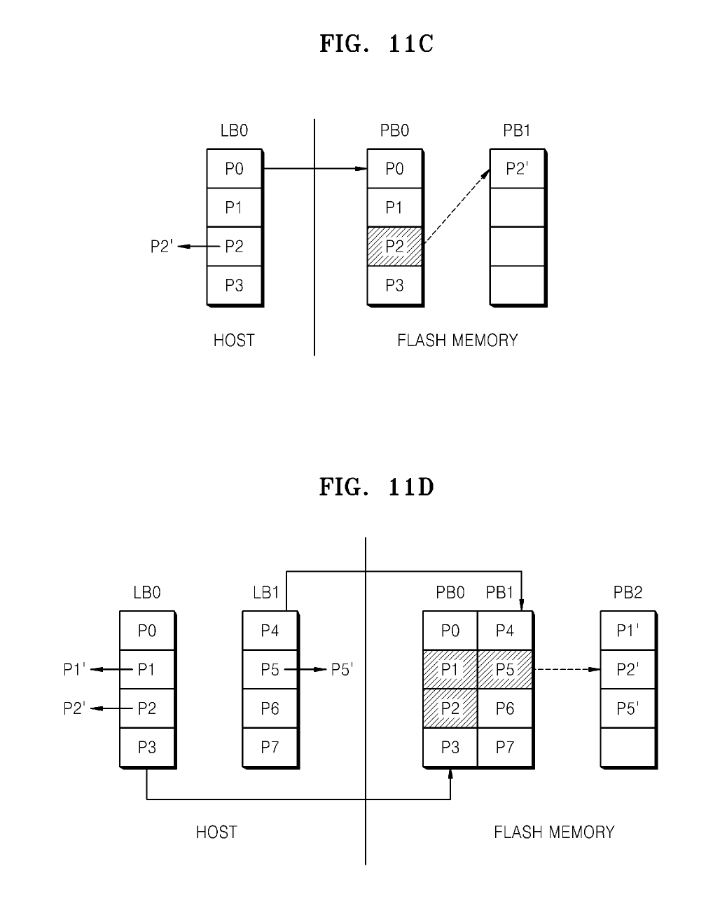

For example, if the mapping method of the data group is set as a fully-associative page mapping method, FTL 103 performs the address translation as illustrated in FIG. 11A. The fully-associative page mapping method is also referred to as a page mapping method.

Referring to FIG. 11A, the address translation is performed based on mapping information generated in units of a page. As such, page mapping information is generated for each of pages P0 through P3 in a logical data block LB0, and logical data block LB0 is address-translated into a log block PB0 based on the page mapping information. Here, a log block refers to a physical block of flash memory 104. After that, if page P2 of logical data block LB0 is updated into page P2′, page mapping information for writing the updated page P2′ is generated and the updated page P2′ is written into a new log block PB1 assigned to the data group. Then, page P2 of log block PB0 is invalidated.

As another example, if the mapping method of the data group is set as a block mapping method, FTL 103 performs the address translation as illustrated in FIG. 11B.

Referring to FIG. 11B, the address translation is performed based on mapping information generated in units of a block. As such, block mapping information is generated regarding all of pages P0 through P3 in a logical data block LB0, and logical data block LB0 is address-translated into a log block PB0 based on the block mapping information. After that, if page P2 of logical data block LB0 is updated into page P2′, block mapping information for writing all pages including the updated page P2′ is generated and pages P0, P1, and P3, and the updated page P2′ are written into a new log block PB1 assigned to the data group. Then, all pages of log block PB0 are invalidated.

As another example, if the mapping method of the data group is set as a block associative mapping method, FTL 103 performs the address translation as illustrated in FIG. 11C. The block associative mapping method is also referred to as a hybrid mapping method.

Referring to FIG. 11C, the address translation is performed based on mapping information generated in units of a block. As such, block mapping information is generated regarding all of pages P0 through P3 in a logical data block LB0, and logical data block LB0 is address-translated into a log block PB0 based on the block mapping information. Thereafter, if page P2 of logical data block LB0 is updated into page P2′, page mapping information for writing the updated page P2′ is generated and the updated page P2′ is written into a new log block PB1 assigned to the data group. Then, page P2 of log block PB0 is invalidated.

As another example, if the mapping method of the data group is set as a 2-block associative mapping method, FTL 103 performs the address translation as illustrated in FIG. 11D.

Referring to FIG. 11D, where original data of logical data blocks LB0 and LB1 is written into flash memory 104, the address translation is performed based on mapping information generated in units of a block. As such, block mapping information is generated for all of pages P0 through P3 in logical data block LB0, and logical data block LB0 is address-translated into a log block PB0 based on the block mapping information. Similarly, other block mapping information is generated regarding all of pages P4 through P7 in logical data block LB1, and logical data block LB1 is address-translated into a log block PB1 based on the other block mapping information.

Then, page mapping information for writing each of updated pages of page data written into two log blocks PB0 and PB1, into one new log block assigned to the data group, is generated. That is, if pages P1 and P2 of logical data block LB0 are respectively updated into pages P1′ and P2′, and page P5 of logical data block LB1 is updated into page P5′, page mapping information for writing each of the updated pages P1′, P2′, and P5′ of logical data blocks LB0 and LB1 into one new log block PB2 is generated. As such, the updated pages P1′, P2′, and P5′ are written into new log block PB2, and pages P1 and P2 of log block PB0, and page P5 of log block PB1 are invalidated.

In an N-block associative mapping method, where original data of a logical data block is written into flash memory 104, mapping information is generated in units of a block. Then, page mapping information for writing each of updated pages of page data written into N log blocks, into one new log block, is generated. The above mapping method is referred to as the N-block associative mapping method.

As described above, FTL 103 may divide log blocks used in each data group. As such, unnecessary copying of cold data in a garbage collection operation may be prevented.

Also, if setup information regarding data groups is defined to use a block mapping method with respect to sequential pages, more free blocks may be assigned to randomly used pages and thus a garbage collection cost may be reduced. Furthermore, by using the block mapping method, the size of mapping data may be reduced.

In addition, because a file system of host device 110 may control over-provision, a mapping algorithm, etc. of each data group, the frequency or cost of garbage collections in each data group may be adjusted. As such, a minimum throughput ensured by data storage system 100 may be adjusted.

FIG. 12 is a flowchart illustrating an interface management method according to an embodiment of the inventive concept. The method of FIG. 12 can be controlled by processor 110-1 of host device 110 illustrated in FIG. 2.

Initially, host device 110 classifies pages stored in storage device 120 into a plurality of data groups according to properties of the pages (S101). That is, host device 110 groups pages stored in storage device 120 into data groups having common properties according to properties of the pages. The data groups may be grouped in units of a data block region including data blocks having continuous logical addresses. That is, usage patterns of the pages may be classified according to properties of files for forming the pages. For example, the properties of the files may be determined by using extension information of the files. As another example, the pages may be classified into a hot data group and a cold data group according to frequencies of updates on the pages.

Thereafter, host device 110 transmits setup information regarding the data groups classified in S101 to storage device 120 (S102).

FIG. 13 is a flowchart illustrating operation S102 of FIG. 12 according to an embodiment of the inventive concept.

Referring to FIG. 13, host device 110 forms setup information regarding the data groups classified in operation S101 (S201). As illustrated in FIG. 4, according to the specifications of a data group setup command, the setup information regarding the data groups may comprise a header, group environment setup information, and data block region information. The header comprises information representing the number of groups defined by a command code, and information representing the number of data block regions. The group environment setup information typically comprises at least one of group number information, information representing a mapping method, information representing page padding, information representing a volatile data region, and information representing the number of log blocks assigned to a group. The information representing the number of log blocks assigned to a group may comprise information representing a ratio of a maximum number of allocable log blocks to the number of data blocks, and information representing a ratio of a minimum number of allocable log blocks to the number of data blocks. The data block region information may comprise information representing an address of a start logical block in a group, length information of a data block, and group number information. Setup values for forming the group environment setup information of each group may be determined by using the lookup table described above.

Then, the setup information regarding the data groups formed in S201 is transmitted to storage device 120 together with an initially defined command code (S202). Here, the command code is defined as a data group setup command code.

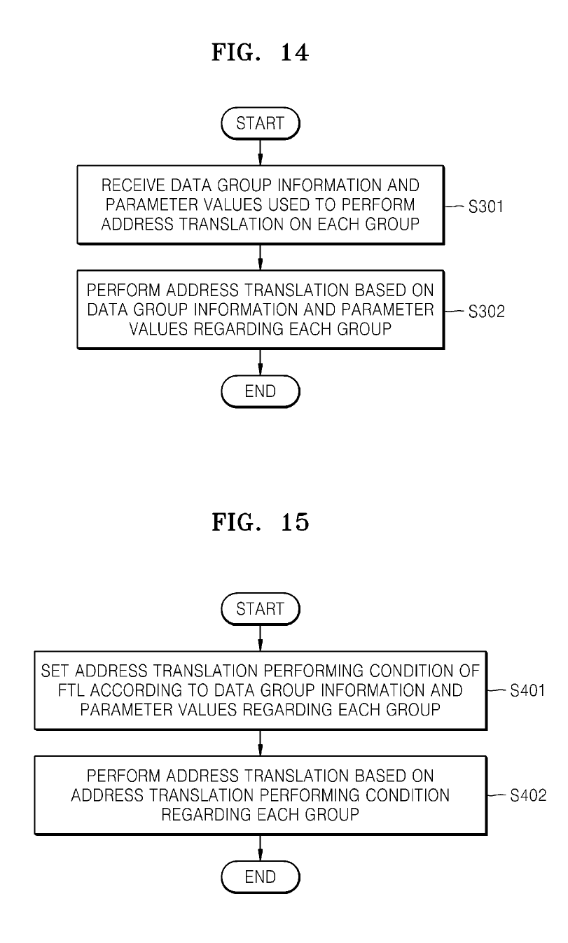

FIG. 14 is a flowchart illustrating a mapping method for storage device 120 according to an embodiment of the inventive concept. The mapping method of FIG. 14 is performed under the control operation of control unit 121-2 of storage device 120.

Storage device 120 receives from host device 110 data group information and parameter values used to perform address translation on each group (S301). In particular, storage device 120 receives a data group setup command code and setup information regarding data groups via host interface 121-1 from host device 110. The setup information regarding the data groups typically comprises the data group information and the parameter values regarding each group. The parameter values received from host device 110 may include values for designating a mapping method and the number of allocable log blocks of each group. The parameter values may also include values represented by flags illustrated in FIG. 4. Next, storage device 120 performs address translation based on the received data group information and the parameter values regarding each group (S302).

FIG. 15 is a flowchart illustrating operation S302 of FIG. 14 according to an embodiment of the inventive concept.

Referring to FIG. 15, storage device 120 sets an address translation performing condition of FTL 103 according to the received data group information and the parameter values regarding each group (S401). That is, storage device 120 may set a mapping method and the number of allocable log blocks of each group according to the received data group information and the parameter values regarding each group. Also, storage device 120 may set whether page padding is used, according to the parameter values regarding each group. Also, storage device 120 checks whether volatile data is written into a corresponding data group, according to the parameter values regarding each group, and manages metadata not to be written into memory device 122 if volatile data is written.

Then, FTL 103 in storage device 120 performs the address translation based on the address translation performing condition of each group (S402). That is, a logical address for performing a write operation is translated into a physical address of storage device 120 by applying the address translation performing condition of FTL 103 determined based on the group environment setup information regarding a data group corresponding to the logical address.

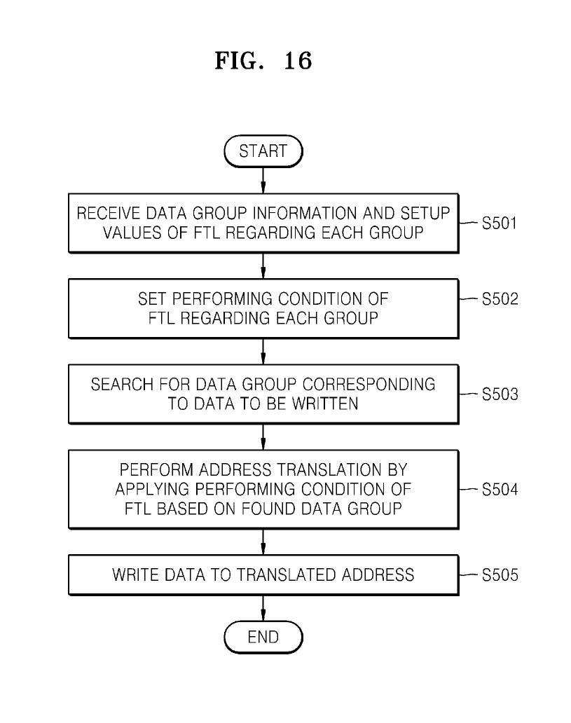

FIG. 16 is a flowchart illustrating a write method for storage device 120 according to an embodiment of the inventive concept.

Referring to FIG. 16, storage device 120 receives from host device 110 data group information and setup values of FTL 103 used to perform address translation on each group (S501). For example, the setup values of FTL 103 may be received according to the specifications of a data group setup command illustrated in FIG. 4. The setup values of FTL 103 may comprise values for designating a mapping method and the number of allocable log blocks of each group. The setup values may also comprise values represented by flags illustrated in FIG. 4.

Thereafter, storage device 120 sets an address translation performing condition of FTL 103 according to the received data group information and the setup values of FTL 103 regarding each group (S502).

Next, a data group corresponding to a logical address for performing a write operation is found (S503). For example, a data group assigned to a data block including a logical address for performing a write operation may be found by using the data block region information in the data group setup command information illustrated in FIG. 4.

Subsequently, address translation is performed by applying the address translation performing condition of FTL 103 based on the found data group (S504). That is, a logical address for performing a write operation is translated into a physical address of storage device 120 by applying the address translation performing condition of FTL 103 determined based on group environment setup information regarding a data group corresponding to the logical address (S505).

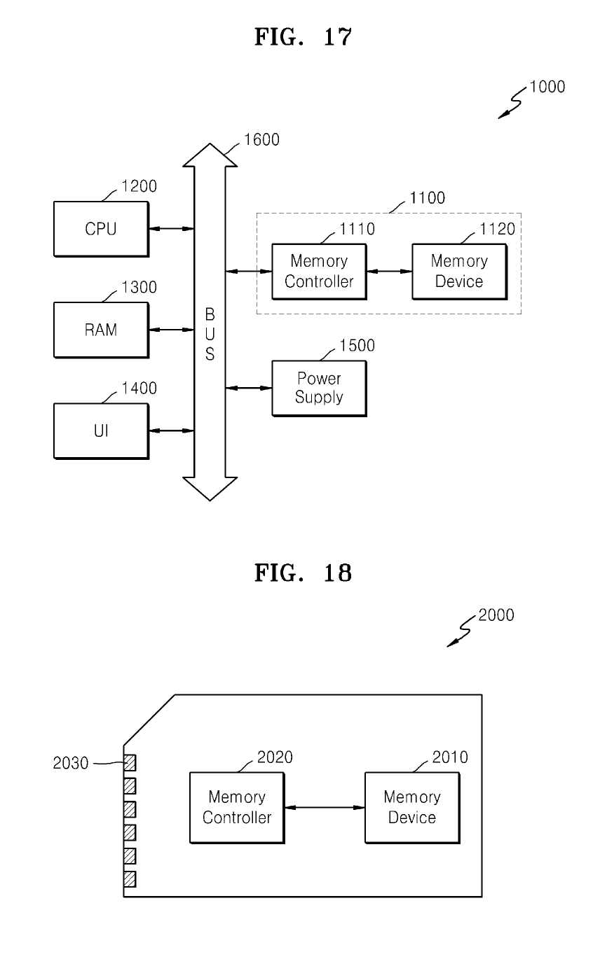

FIG. 17 is a block diagram of a computer system 1000 according to an embodiment of the inventive concept.

Referring to FIG. 17, computer system 1000 comprises a central processing unit (CPU) 1200, a RAM 1300, a UI 1400, and a storage device 1100 electrically connected via a bus 1600. Storage device 1100 comprises a memory controller 1110 and a memory device 1120. Memory device 1120 stores, via memory controller 1110, data processed or to be processed by CPU 1200. Storage device 1100 can be implemented as storage device 120 of FIG. 1. Also, CPU 1200 may be implemented as processor 110-1 of host device 110 illustrated in FIG. 2. Computer system 1000 further comprises a power supply 1500.

Where computer system 1000 is a mobile device, power supply 1500 may be a battery. Computer system 1000 may further comprise features not shown in FIG. 17, such as a modem comprising a baseband chipset, an application chipset, a camera image processor (CIS), and a mobile DRAM, for example.

FIG. 18 is a block diagram of a memory card 2000 according to an embodiment of the inventive concept.

Referring to FIG. 18, memory card 2000 comprises a memory controller 2020 and a memory device 2010. Memory controller 2020 controls write and read operations of memory device 2010 in response to a request of an external host received via an input/output (I/O) interface 2030. To facilitate these operations, memory controller 2020 of memory card 2000 may comprise, for example, an interface for interfacing between the host and memory device 2010, and RAM. Memory card 2000 may be implemented as storage device 120 of FIG. 1.

Memory card 2000 can be implemented as a compact flash card (CFC), a micro drive, a smart media card (SMC), a multimedia card (MMC), a security digital card (SDC), a memory stick, or a USB flash memory driver.

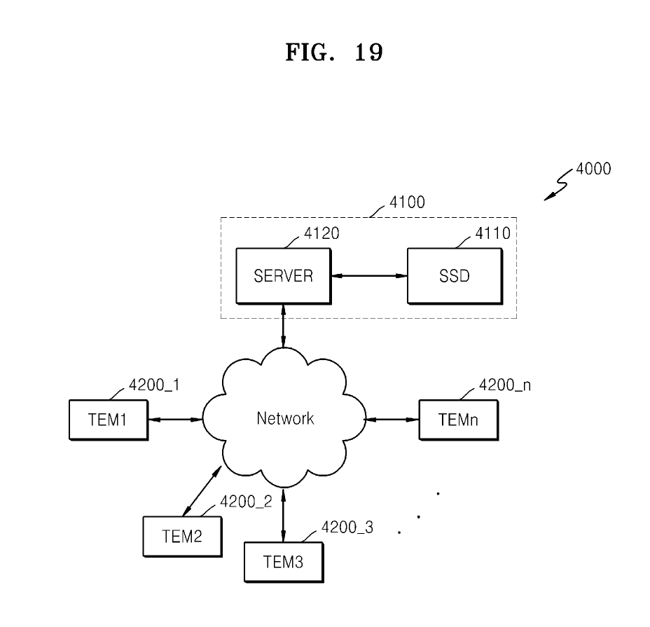

FIG. 19 is a block diagram of a network system 4000 and a server system 4100 comprising an SSD 4110 according to an embodiment of the inventive concept.

Referring to FIG. 19, network system 4000 comprises server system 4100 and a plurality of terminals 4200_1 through 4200_n connected in a network. Server system 4100 comprises a server 4120 for processing requests received from terminals 4200_1 through 4200_{—}n connected in the network, and SSD 4110 for storing data corresponding to the requests received from terminals 4200_1 through 4200_{—}n. In this case, SSD 4110 may be implemented as storage device 120 of FIG. 1.

Data storage system 100 of FIG. 1 may be mounted by using various types of packages, e.g., a package on package (POP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small-outline integrated circuit (SOIC), a shrink small outline package (SSOP), a thin small outline package (TSOP), a system in package (SIP), a multi chip package (MCP), a wafer-level fabricated package (WFP), and a wafer-level processed stack package (WSP). The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method, comprising:
classifying pages stored in a solid state drive into a plurality of data groups according to properties of the pages; and
transmitting setup information regarding the classified data groups to the solid state drive.

2. The method of claim 1, wherein the pages are classified into a plurality of data groups according to properties of files forming the pages.

3. The method of claim 2, wherein the properties of the files are determined based on extension information of the files or types of the files.

4. The method of claim 1, wherein the pages are classified into a plurality of data groups according to frequencies of updates on the pages.

5. The method of claim 1, wherein the setup information regarding the data groups is transmitted from a file system of a host device to a flash translation layer (FTL) of the solid state drive.

6. The method of claim 1, wherein the setup information regarding the data groups is transmitted together with an initially defined command code, and
wherein the command code is defined as a data group setup command code.

7. The method of claim 1, wherein the setup information regarding the data groups comprises a header, group environment setup information, and data block region information.

8. The method of claim 7, wherein the header comprises information representing the number of groups defined by a command code, and information representing the number of data block regions.

9. The method of claim 7, wherein the group environment setup information comprises at least one of group number information, information representing a mapping method, information representing page padding, information representing a volatile data region, and information representing the number of log blocks assigned to a group.

10. The method of claim 9, wherein the information representing the number of log blocks assigned to a group comprises information representing a ratio of a maximum number of allocable log blocks to the number of data blocks, and information representing a ratio of a minimum number of allocable log blocks to the number of data blocks.

11. The method of claim 7, wherein the data block region information comprises information representing an address of a start logical block in a group, length information of a data block, and group number information.

12. A method comprising:
receiving from a host device data group information for a plurality of data groups and parameter values used to perform address translation on each of the groups; and
translating a logical address of data to be stored into a physical address based on the received data group information and the parameter values corresponding to the respective groups.

13. The method of claim 12, wherein the parameter values comprise values for designating a mapping method and a number of allocable log blocks of each of the groups.

14. The method of claim 12, wherein the data group information and the parameter values for each of the groups are transmitted together with an initially defined command code, and
wherein the command code is defined as a data group setup command code.

15. The method of claim 12, further comprising writing data of a logical address designated by a write command, to the translated physical address.

16. A system, comprising:
a solid state drive comprising a nonvolatile memory device; and
a host device configured to classify pages stored in the solid state drive into a plurality of data groups according to properties of the pages, and further configured to transmit setup information regarding the classified data groups to the solid state drive.

17. The system of claim 16, wherein the setup information comprises data group information for the data groups and parameter values used to perform address translation on each of the groups, and the solid state drive receives the setup information from the host device and translates a logical address of data to be stored into a physical address based on the received data group information and the parameter values corresponding to the respective groups.

18. The system of claim 16, wherein the pages are classified into a plurality of data groups according to properties of files forming the pages.

19. The system of claim 18, wherein the properties of the files are determined based on extension information of the files or types of the files.

20. The system of claim 16, wherein the parameter values comprise values for designating a mapping method and a number of allocable log blocks of each of the groups.
